(19) United States
(12) Patent Application Publication
(10) Pub. No.: US 2026/0320583 A1
(43) Pub. Date: Oct. 15, 2026

(54) ENHANCED SECURITY CREDIT CARD AND DOCUMENT AUTHENTICATION

(71) Applicant: Bank of America Corporation, Charlotte, NC (US)

(72) Inventors: Maharaj Mukherjee, Poughkeepsie, NY (US); George Albero, Charlotte, NC (US)

(21) Appl. No.: 19/178,798

(22) Filed: Apr. 14, 2025

(51) Int. Cl. G06Q 20/34; G06Q 20/32; G06Q 20/38; G06Q 20/40

(52) U.S. Cl. CPC G06Q 20/3552; G06Q 20/3278; G06Q 20/3829; G06Q 20/4014

(57) ABSTRACT

Apparatus and methods for enhanced security and authentication for credit cards and documents are provided. The enhanced security credit card or document may include non-visible authentication data. The enhanced security credit card or document may include a low-power NFC device. When the enhanced security credit card or document is brought near a mobile device, the mobile device may generate the authentication or security information. The authentication or security information may be displayed on the mobile device. In an embodiment, various parts of the authentication or security information may be generated by multiple devices, or multiple partitions of one device.

### FIELD OF TECHNOLOGY

Aspects of the disclosure relate to enhanced security credit cards and documents. Specifically, aspects of the disclosure relate to apparatus and methods for enhanced security and authentication for credit cards and documents.

### BACKGROUND OF THE DISCLOSURE

Credit (and debit) cards are among the most widely used payment forms in use today. It is anticipated that they will continue to be widely used for payment for the foreseeable future.

Credit cards currently have a variety of features, including sixteen (or more) digits for the credit card number, one or more card security codes, expiration dates, cardholder names, EMV chips, magnetic data strips, and other features. Many of these features provide security and are printed or included with a credit card.

One vulnerability for credit cards may be the physical printing of credit card data such as the credit card number, expiration date, cardholder name, and card security codes. If the physical card is lost or stolen, a malicious actor may have most or all of the information necessary to use the credit card online or elsewhere.

Removing (i.e., not printing) this data on the physical card may reduce or eliminate this vulnerability. However, removing the card data may reduce the functionality of using the card by the cardholder or other authorized user.

Therefore, it would be desirable to reduce or eliminate this vulnerability while also maintaining functionality for an authorized user.

The methods of maintaining functionality described in this disclosure may also be used to electronically authenticate and secure physical documents and other physical items.

This disclosure provides apparatus and methods enhanced security credit card and document authentication.

### SUMMARY OF THE DISCLOSURE

It is an object of this disclosure to provide apparatus and methods for enhanced security credit card and document authentication.

An enhanced security credit card is provided, the enhanced security credit card may have a thickness not greater than 0.8 millimeters (“mm”) and a surface area not greater than 86 mm ×54 mm.

The enhanced security credit card may include an EMV chip, a front surface, a back surface, a non-transitory memory, and a near-field wireless communication (“NFC”) interface configured to provide NFC wireless communication, among other components.

When the enhanced security credit card is within a pre-determined proximity of a mobile device, the enhanced security credit card may be configured to communicate over the NFC wireless communication interface with the mobile device. The communication may include a command to automatically launch an application on the mobile device.

The application may be configured to authenticate a user of the credit card. The application may be configured to retrieve card data from the non-transitory memory. The application may be configured to automatically generate a random security code. The application may be configured to display the random security code on a screen of the mobile device. The application may be configured to display a credit card number (and other data) corresponding to card payment data on the screen of the mobile device. The application may be configured to transmit the random security code and the card data to a credit card payment processing service.

In an embodiment, when the user fails to be authenticated, the application may be configured to display a message describing the failure to authenticate.

In an embodiment, the message if there is a failure to authenticate may be a message similar to “This card is lost or stolen.” In an embodiment, the non-transitory memory may store the credit card number, a name of the user associated with the enhanced security credit card (i.e., the cardholder or authorized user), an expiration date for the card number, a maximum spending limit value associated with the card number, a telephone number associated with the card number, and other data.

In an embodiment, the front surface may have no alphanumeric indicia identifying card payment data such as the card number, the security code, a date of expiration, and a name of the user, or other card data.

In an embodiment, the back surface may have no alphanumeric indicia identifying card payment data such as the card number, the security code, a date of expiration, and a name of the user, or other card data.

In an embodiment, the application may be configured to, in two or more partitions on the mobile device: authenticate the user; automatically generate the random security code; retrieve the credit card number corresponding to card payment data from the non-transitory memory; retrieve a name of the cardholder from the non-transitory memory; and retrieve a date of expiration of the credit card from the non-transitory memory.

In an embodiment, the enhanced security credit card may include a power source.

In an embodiment, the power source may be rechargeable.

In an embodiment, the authentication process may include use of one or more biometric authenticators.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure.

FIG. 2 shows an illustrative apparatus in accordance with principles of the disclosure.

FIG. 3 shows an illustrative apparatus in accordance with principles of the disclosure.

FIG. 4 shows an illustrative apparatus in accordance with principles of the disclosure.

FIG. 5 shows an illustrative flowchart in accordance with principles of the disclosure.

FIG. 6 shows an illustrative schematic in accordance with principles of the disclosure.

FIG. 7 shows an illustrative schematic in accordance with principles of the disclosure.

### DETAILED DESCRIPTION OF THE DISCLOSURE

An enhanced security credit card is provided. For the purposes of the disclosure, an enhanced security credit card and/or an enhanced security credit card may be understood to refer to any debit or credit card that generally shares the dimensions of a typical debit or credit card and may, in certain circumstances and configurations, be used to perform transactions. The enhanced security credit card may include near-field wireless communication (“NFC”) capabilities. The enhanced security credit card may be in wireless communication with an application on a mobile device.

An enhanced security credit card is provided. The enhanced security credit card may have a thickness not greater than 0.8 millimeters (“mm”) and a surface area not greater than 86 mm×54 mm. This may be considered the standard or typical credit card size.

The enhanced security credit card may include an EMV chip, a front surface, a back surface, and an NFC wireless communication interface configured to provide wireless communication, among other components. The EMV chip is an Europay, Mastercard, and Visa chip standard. An EMV chip may store a credit card number and other data to allow for credit card transactions at a point-of-sale (“POS”) terminal equipped with an EMV chip reader.

The enhanced security credit card may include an NFC communication interface. The communication interface may have a thickness that is not greater than 0.8 mm. The communication interface may include circuity for establishing electronic communication with a device. The communication interface may be configured to implement protocols for wireless communication. The communication interface may include one or more antennae for transmitting and receiving wireless signals. The communication interface may use NFC technology.

The communication interface may include communication circuitry. The communication circuitry may include software and/or hardware for establishing a wired or wireless communication channel with the device. The communication interface may be compatible with illustrative wireless channels such as Wi-Fi, Bluetooth, Ethernet, NFC, Satellite and cellular telecommunications. Wi-Fi may include passive Wi-Fi with lower power consumption than typical Wi-Fi. The communication interface may include a Near-Field Communication (“NFC”) chip. The NFC chip may communicate over a typical NFC range (~2 in.) when transmitting or receiving sensitive data. An illustrative NFC chip may utilize a 13.56 MHz radio frequency.

When the enhanced security credit card is within a pre-determined proximity of a mobile device, the enhanced security credit card may be configured to communicate over the NFC wireless communication interface with the mobile device. The communication may include a command to automatically launch an application on the mobile device.

In some situations, the power for the communication may be provided by the enhanced security card (via a battery or otherwise). In other embodiments, the power may be transmitted wirelessly from the mobile device to the enhanced security card. For example, when the enhanced security card is within a pre-determined distance from the mobile device, the mobile device may provide power wirelessly to the enhanced security card. Beyond that pre-determined distance, no power may be provided, and the enhanced security card will not communicate with the mobile device.

The application may be configured to authenticate a user of the credit card. Any suitable authentication method or methods may be used.

The application may be configured to automatically generate a random security code. In a standard credit card, the security code is static and printed on the face (or back) of the credit card, where a malicious actor can see the code.

The application may be configured to display the random security code on a screen of the mobile device. The application may be configured to display a credit card number corresponding to card payment data on the screen of the mobile device. Typical credit card numbers are sixteen or seventeen digits long. Displaying the code and credit card number, along with other card data may allow an authorized user to use the credit card data for an online or telephonic transaction.

The application may be configured to transmit the random security code and the credit card number to a credit card payment processing service. Every credit card is linked to an existing credit card payment processing service, such as Visa or Mastercard. When the application generates a new random security code, that code must be transmitted to the processing service to link the code to the correct card in order that a transaction may be completed.

In an embodiment, the transmission may be encrypted. Any suitable encryption method may be used.

In an embodiment, when the user fails to be authenticated, the application may be configured to display message describing the failure to authenticate.

In an embodiment, the message if there is a failure to authenticate may be a message similar to “This card is lost or stolen.” Other, similar, messages may be displayed. In an embodiment, the application may lock, to prevent further attempts. In other embodiments, the application may provide additional, limited or unlimited, attempts for a user to authenticate.

In an embodiment, the non-transitory memory may store the credit card number, a name of the user associated with the enhanced security credit card (i.e., the cardholder or authorized user), an expiration date for the card number, a maximum spending limit value associated with the card number, a telephone number associated with the card number, and other data.

In an embodiment, the front surface may have no alphanumeric indicia identifying card payment data such as the card number, the security code, a date of expiration, and a name of the user, or other card data. This lack of printed alphanumeric data may provide further security in the event the card is lost, stolen, or misplaced.

In an embodiment, the back surface may have no alphanumeric indicia identifying card payment data such as the card number, the security code, a date of expiration, and a name of the user, or other card data. This lack of printed alphanumeric data may provide further security in the event the card is lost, stolen, or misplaced.

In an embodiment, the application may be configured to, in two or more partitions on the mobile device: authenticate the user, automatically generate the random security code, retrieve the credit card number corresponding to card payment data from the non-transitory memory, retrieve a name of the cardholder from the non-transitory memory, and retrieve a date of expiration of the credit card from the non-transitory memory.

Dividing up the actions of the application into multiple partitions may increase security. The partitions may be physical (hardware-based) and/or logical (software-based) partitions.

In an alternative embodiment, instead of two or more partitions on a single mobile device, the actions may be split among multiple mobile devices. Having multiple users or devices authenticate and approve a credit card transaction may increase security. Each mobile device may include a copy of the application. The application may be configured to: authenticate the user on one of the two or more mobile devices, automatically generate the random security code on one of the two or more mobile devices, retrieve the credit card number corresponding to card payment data from the non-transitory memory, retrieve, on one of the two or more mobile devices, a name of the cardholder from the non-transitory memory, and retrieve, on one of the two or more mobile devices, a date of expiration of the credit card from the non-transitory memory, among other actions. Each of the two or more mobile devices should perform at least one of actions listed above.

In an embodiment, the pre-determined proximity may be a proximity that enables a near-field communication (“NFC”) between the enhanced security credit card and the mobile device. This proximity may be determined by the hardware available to the mobile device. The proximity distance may be static. The proximity distance may be variable. The proximity distance may be varied automatically by the application.

In an embodiment, the enhanced security credit card may include a power source. The power source may be a battery. In an embodiment, the power source may be external, e.g., as in wireless charging capability.

In an embodiment, the power source may be rechargeable.

In an embodiment, the enhanced security credit card may include non-transitory memory. The non-transitory memory may be in addition to the data stored in an EMV chip and the magnetic data stripe.

In an embodiment, the authentication process may include use of one or more biometric authenticators. Biometric authenticators may be more secure than a standard authentication method.

In an embodiment, the random security code may be generated based on an amount of a transaction. For example, a smaller transaction may generate a shorter random security code (e.g., four digits). A larger transaction may generate a longer random security code (e.g., six or ten digits). The threshold between smaller and larger transactions (e.g., $500) may be set by the cardholder, a financial institution, and/or the application. The threshold may be static or dynamic. The threshold may be automatically adjusted after an analysis by an artificial intelligence/machine learning (“AI/ML”) algorithm. Any appropriate AI/ML algorithm or algorithms may be used.

In an embodiment, the random security code may be generated based on an identity of a merchant. For example, more secure or more trustworthy merchants may lead to a shorter random security code. Less secure or trustworthy merchants may generate a longer random security code.

In an embodiment, the random security code may be generated based on a location of the merchant. For example, even a generally secure or trustworthy merchant may have a particular location or franchise that may be considered less secure or trustworthy. In that situation, a longer random security code may be generated. Alternatively, all merchants in a particular geographic area or location may require a shorter or longer random security code.

An enhanced security document system is provided. The enhanced security document system may include an enhanced security document and a mobile device. Some or all of the embodiments described above with respect to an enhanced security credit card may be applicable to an enhanced security document as well.

The enhanced security document may include a power supply, a proximity sensor, an NFC wireless communication interface configured to provide NFC wireless communication, and a non-transitory memory module. The non-transitory memory module may be configured to store data, such as document authentication data, metadata, and one or more digital signatures.

Each of the components of the document should, ideally, be as thin and light as possible. In an embodiment, the document and its components would be no thicker than 0.8 millimeters (“mm”).

The mobile device may include non-transitory memory along with other components (such as a processor and display). The non-transitory memory may be configured to store an application.

When the proximity sensor senses that the enhanced security document is within a pre-determined distance from the mobile device, a signal may be transmitted from the NFC wireless communication interface to the mobile device instructing the mobile device to open the application.

The application may be configured to: authenticate a user, retrieve the data from the document's memory module, authenticate the enhanced security document, and display the data on a screen of the mobile device.

In an embodiment, the application may prompt the user to digitally sign the document. This may be a first signature, or an additional signature. The signature may be initials instead of a full signature.

In an embodiment, the application may be configured to, in two or more partitions on the mobile device: authenticate the user, retrieve the document data, authenticate the document, and display the data. Dividing up the actions of the application into multiple partitions may increase security. The partitions may be physical (hardware-based) and/or logical (software-based) partitions.

In an alternative embodiment, instead of two or more partitions on a single mobile device, the actions may be split among multiple mobile devices. Having multiple users or devices authenticate and approve a credit card transaction may increase security. Each mobile device may include a copy of the application. The application may be configured to: authenticate the user on one of the two or more mobile devices, retrieve the data on one of the two or more mobile devices, authenticate the document on one of the two or more mobile devices, and display the document data on one or more of the two or more mobile devices. Other actions may be performed as well (such as, e.g., prompting the user for a digital signature). Each of the two or more mobile devices should perform at least one of actions listed above.

In an embodiment, the power supply may be rechargeable.

In an embodiment, the power supply may obtain power wirelessly from a mobile device or other power source. For example, wireless charging.

In an embodiment, the data on the non-transitory memory may be re-writable by the application.

A method for enhancing security and authentication of a credit card or a document is provided. The credit card may have a thickness not greater than 0.8 millimeters (“mm”) and a surface area not greater than 86 mm×54 mm.

The method may include the step Of storing authentication data in a database associated with an application on a mobile device belonging to a user. The authentication data may be with respect to authenticating the user, authenticating the document (e.g., a database with information on all of the authenticated documents available in a system), authenticating a credit card, or other authentication data.

When a proximity sensor on the document or credit card senses that the enhanced security document or credit card is within a pre-determined distance from the mobile device, the method may include the step of transmitting a signal from an NFC wireless communication interface to the mobile device instructing the mobile device to open the application.

In an embodiment, the proximity sensor may be on the mobile device. When the sensor is on the mobile device, when the mobile device senses that an enhanced security document or credit card is within a pre-determined distance from the mobile device the method may include the step of transmitting a signal from the mobile device to read the credit card or document, as well as automatically opening the application.

The method may include the step of authenticating the user. Any suitable authentication method may be used.

The method may include the step of determining whether the enhanced security document or credit card is a document or a credit card. The determination may be made by analyzing the signal, analyzing the credit card or document visually (e.g., through a camera), or by retrieving data from non-transitory memory of the document or credit card, such as identifying metadata/headers etc. In an embodiment, a user may choose whether the enhanced security document or credit card is a document or a credit card.

When the enhanced security document or credit card is a document, the method may include the steps of retrieving document data from a memory module of the document, authenticating the document, and displaying the document data on a screen of the mobile device.

When the enhanced security document or credit card is a credit card, the method may include the steps of automatically generating a random security code, displaying the random security code and the card data on a screen on the mobile device, and transmitting the random security code and the card data to a credit card payment processing service.

The term “non-transitory memory,” as used in this disclosure, is a limitation of the medium itself, i.e., it is a tangible medium and not a signal, as opposed to a limitation on data storage types (e.g., RAM vs. ROM). “Non-transitory memory” may include both RAM and ROM, as well as other types of memory.

Non-transitory memory may be configured to store executable data configured to run on a processor or read by a separate computing device.

The microprocessors may control the operation of the computer system and its components, which may include RAM, ROM, an input/output module, and other memory.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, bluetooth, LAN, and cellular links. Multiple communication links may be present. In an embodiment, the network used to communicate may be the Internet. In another embodiment, the network may be an internal intranet or other internal network.

In an embodiment, the enhanced security credit card or document may also include a microprocessor.

The enhanced security credit card or document may include various other components, such as a battery, a speaker, and antennas. The microprocessor may have a thickness that is not greater than 0.25 millimeters (“mm”). The microprocessor may control overall operation of the enhanced security credit card or document and its associated components. The enhanced security credit card or document may include RAM, ROM, an input/output (“I/O”) module and a non-transitory or nonvolatile memory.

The I/O module may include a microphone which may accept user provided input. The I/O module may include one or more speaker(s) for providing audio output and a touch screen for providing textual, audiovisual and/or graphical output. Software may be stored within the non-transitory memory and/or other storage media. The software may provide instructions to the microprocessor for enabling the enhanced security credit card or document to perform various functions. For example, the non-transitory memory may store software used by the enhanced security credit card or document, such as an operating system and application programs.

Alternatively, some or all of the computer executable instructions of the enhanced security credit card or document may be embodied in hardware or firmware components of the enhanced security credit card or document, or a separate computer system, such as a mobile device. Application programs, which may be used by the enhanced security credit card or document, may include computer executable instructions for invoking user functionality related to communication, authentication services, and voice input and speech recognition applications. Application programs may utilize one or more algorithms that encrypt information, process received executable instructions, interact with a POS terminal and perform power management routines or other suitable tasks. The enhanced security credit card or document may include one or more non-transitory memory locations. The microprocessor may access such memory locations. The non-transitory memory locations may be included in the microprocessor. The non-transitory memory locations may store software, that when executed by the microprocessor, cause the enhanced security credit card or document to perform various functions.

In some embodiments, the enhanced security credit card or document may be activated in response to receiving high frequency wireless signals. The high frequency signals may be detected by the communication interface. The high frequency signals may be generated by a near field communication (“NFC”) reader. The NFC reader may be embedded within a mobile device within the pre-determined proximity of the enhanced security credit card or document. The high frequency signals may provide power to one or more components of the enhanced security credit card or document. In some embodiments, in response to receiving the power, the microprocessor may be activated and begin to draw power from a battery on the enhanced security credit card or document.

The enhanced security credit card or document may operate in a networked environment. The enhanced security credit card or document may support establishing communication channels with one or more devices. The enhanced security credit card or document may connect to a local area network (“LAN”), a wide area network (“WAN”) or any suitable network. When used in a LAN networking environment, the enhanced security credit card or document may be connected to the LAN through a network interface or adapter. The communication interface may include the network interface or adapter.

When used in a WAN networking environment, the enhanced security credit card or document may include a modem or other means for establishing communications over a WAN, such as the Internet. The communication interface may include the modem. It will be appreciated that the network connections shown are illustrative and other means of establishing a communications link between devices may be used. The existence of any of various well known protocols such as TCP/IP, Ethernet, FTP, HTTP and the like is presumed.

The enhanced security credit card or document may utilize computer-executable instructions, such as program modules, being executed by a microprocessor. Generally, program modules include routines, programs, objects, components, data structures, etc. that perform particular tasks or implement particular abstract data types. The enhanced security credit card or document may be operational with distributed computing environments where tasks are performed by remote processing devices that are linked through a communications network. In a distributed computing environment, program modules may be located in both local and remote computer storage media including memory storage devices.

The enhanced security credit card or document may include one or more batteries. A battery of the enhanced security credit card or document may be flexible. The battery may be a power source for electronic components of the enhanced security credit card or document. For example, the battery may supply power to the communication interface, memory, and the microprocessor if used. The battery may have a thickness that is not greater than 0.5 mm.

The battery may be recharged via an electrical contact, such as, for example, when the enhanced security credit card or document is in contact with a device. The enhanced security credit card's or document's power source may include high frequency signals received from a device. The enhanced security credit card or document may be configured to utilize received high frequency signals to recharge the battery or provide power to other components of the enhanced security credit card or document.

The enhanced security credit card or document may include an electrical contact. An electrical contact may be constructed using any suitable material that conducts or transfers electricity. The enhanced security credit card or document may include a plurality of electrical contacts. An electrical contact may be accessible on any suitable face of the enhanced security credit card or document. The contact may be accessible through a thickness of the card or document. The contact may be utilized to transfer electrical charge to a rechargeable battery when the enhanced security credit card or document is inserted into a device.

An enhanced security credit card or document may interact with an application or other application on a user's mobile device.

The application may be set up via the user's financial institution. The application may be configured to store credit/debit card payment data for each of the user's cards. The application may also store additional information.

Card payment data for each card may include a static card number and the expiration date associated with each card number. The card payment data may also include a static security code associated with each card number, and the cardholder's name, as well as other information.

When the enhanced security credit card or document is within a pre-determined proximity of a mobile device, the enhanced security credit card or document may be configured to communicate with the mobile device. The pre-determined proximity may be a proximity that may enable a near-field communication (“NFC”) between the enhanced security credit card or document and the mobile device.

To authenticate the user/cardholder and allow for determining a random security code or displaying card or document data for the cardholder to user, the application on the mobile device may verify/authenticate the user using any appropriate authentication method or protocol. Methods may include username/password, PIN input, one-time password, biometric authenticators, and other authentication methods.

The communication may include a request for input of a personal identification number (“PIN”) associated with an enhanced security credit card account or other account of the user. The application may receive input of the PIN, by the user of the enhanced security credit card or document. The application may be configured to verify that the PIN matches the PIN stored in the authentication data/profile of the user of the mobile device and the enhanced security credit card or document.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMS, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e. g., air and/or space).

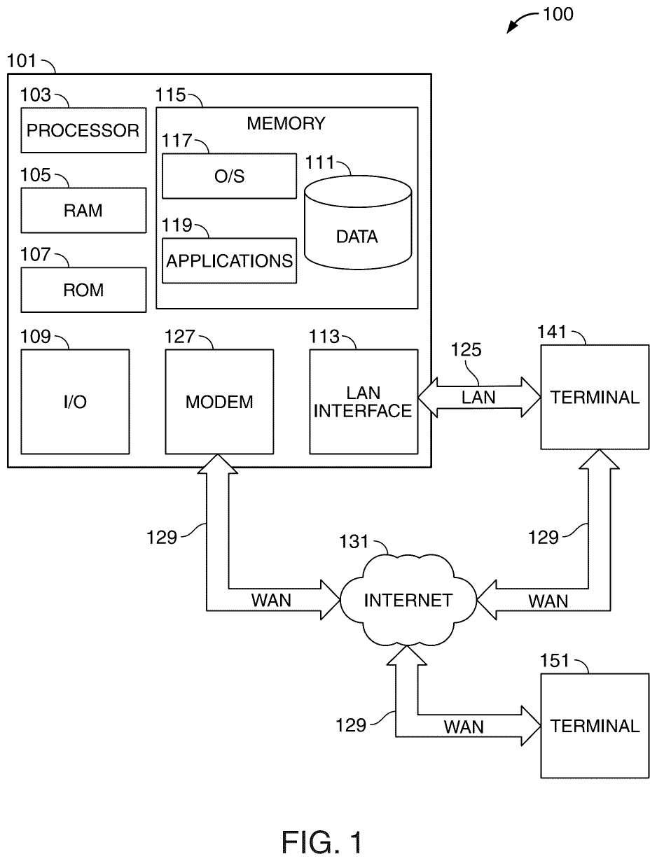

In accordance with principles of the disclosure, FIG. 1 shows an illustrative block diagram of apparatus 100 that includes computer 101. Computer 101 may alternatively be referred to herein as a “computing device.” Elements of apparatus 100, including computer 101, may be used to implement various aspects of the apparatus and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101—e.g., the operating system 117 and applications 119 such as an application and security protocols. Other components commonly used for computers, such as EEPROM or Flash memory or any other suitable components, may also be part of the computer 101.

The memory 115 may be comprised of any suitable permanent storage technology—e.g., a hard drive or other non-transitory memory. The ROM 107 and RAM 105 may be included as all or part of memory 115. The memory 115 may store software including the operating system 117 and application(s) 119 (such as an application and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies. A preferred embodiment may be NFC communications.

Any memory may be comprised of any suitable permanent storage technology—e.g., a hard drive or other non-transitory memory. The memory may store software including an operating system and any application(s) (such as an application and security protocols) along with any data needed for the operation of the apparatus. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple Computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is world-wide network. “Cloud-based applications” generally refer to applications located on a server remote from a user, wherein some or all of the application data, logic, and instructions are located on the internet and are not located on a user's local device. Cloud-based applications may be accessed via any type of internet connection (e.g., cellular or wi-fi).

Terminals 141 and 151 may be personal computers, smart mobile devices, smartphones, IoT devices, or servers that include many or all of the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, wi-fi, cellular networks, NFC networks, or other suitable frequencies.

It will be appreciated that the network connections shown are illustrative and other means of establishing a. communications link between enhanced security credit cards or documents and mobile devices/computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer executable instructions for an application and security protocols, as well as other programs. In an embodiment, one or more programs, or aspects of a program, may use one or more AI/ML algorithm(s). The various tasks may be related to enhancing security and authentication for credit cards or documents.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smart phones, other Computers, and/or other personal digital assistants (“PDAS”), multiprocessor systems, microprocessor-based systems, set top boxes, programmable consumer electronics, network PCS, minicomputers, mainframe computers, distributed computing environments that include any of the above systems or devices, IoT devices, and the like.

Aspects of the invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In distributed computing environment, program modules may be located in both local and remote computer storage media including memory storage devices.

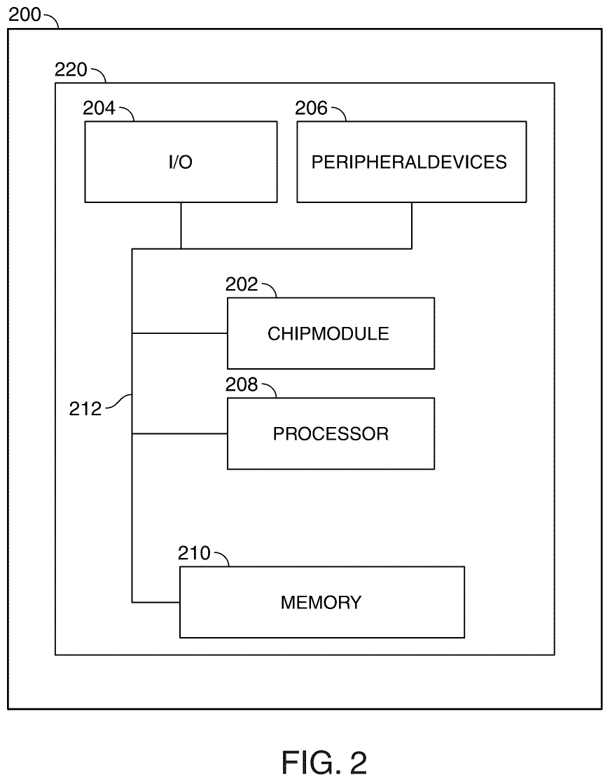

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures; machine executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

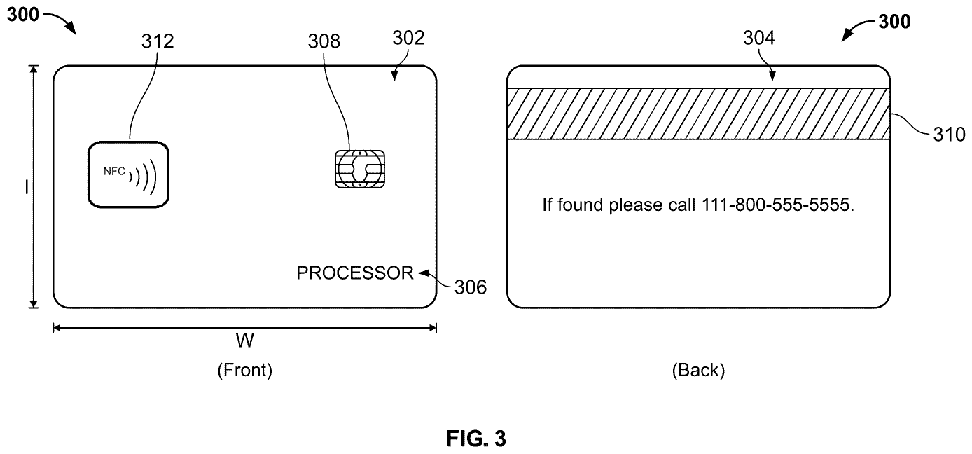

FIG. 3 shows an enhanced security credit card 300 in accordance with principles of the disclosure. Enhanced security credit card 300 may be associated with a user. Enhanced security credit card 300 may be a debit or credit card.

Enhanced security credit card 300 may have a width w and length l. Enhanced security credit card 300 may be any suitable size consistent with standard credit card sizes. For example, width w may be 53.98 millimeters (“mm”). Length l may be 85.60 mm. Enhanced security credit card 300 may have a thickness t. An illustrative thickness may be 0.8 mm. An exemplary form factor of enhanced security credit card 300 may be 53.98 mm×85.60 mm×0.8 mm. This exemplary form factor may allow enhanced security credit card 300 to fit into a user's wallet or pocket. This exemplary form factor may allow enhanced security credit card 300 to fit into a card reader of an ATM and/or any suitable POS device.

Enhanced security card may have a front surface 302 and a back surface 304. As shown, card data is not printed on either the front surface 302 or the back surface 304. Some information, such as the credit card processing service 306 and other information may be printed on the enhanced security card 300.

Enhanced security card 300 may include components such as an EMV chip 308, NFC communications capability 312, and a magnetic data strip 310, as well as other components such as non-transitory memory (not shown), a battery (not shown) and a microprocessor (not shown).

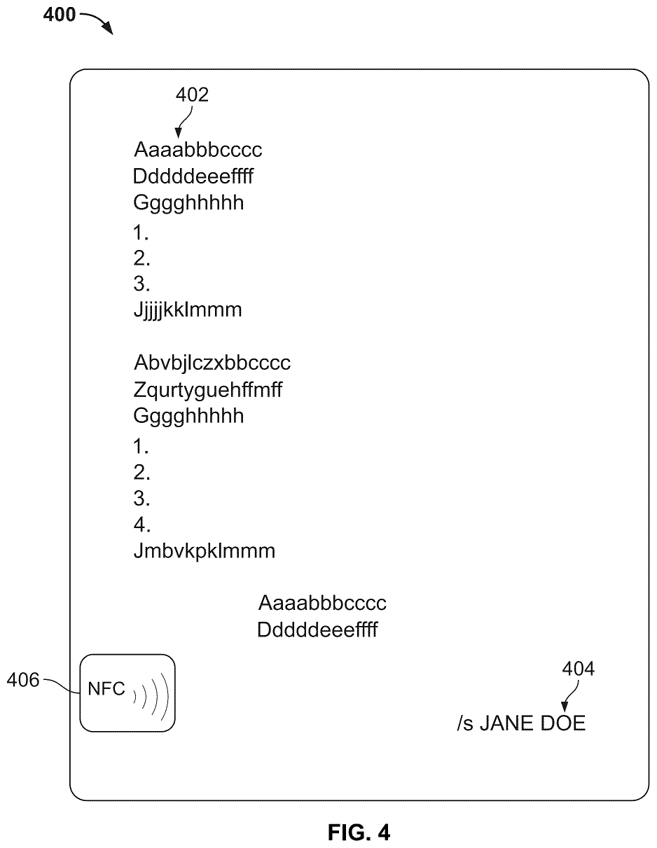

FIG. 4 shows an exemplary enhanced security document in accordance with principles of the disclosure.

An enhanced security document 400 may include document text/data 402, a signature 404, and an NFC chip 406, among other components, such as a battery (not shown) and non-transitory memory module (not shown).

Signature 404 may be a digital signature or a physical signature. Other components may include a battery, memory module, and other components.

An enhanced security document 400 may be thicker than a standard piece of paper. One possible embodiment would be a trading card (e.g., sports cards or card games). In this embodiment, the components would allow for quick, easy, and certified authentication of valuable cards.

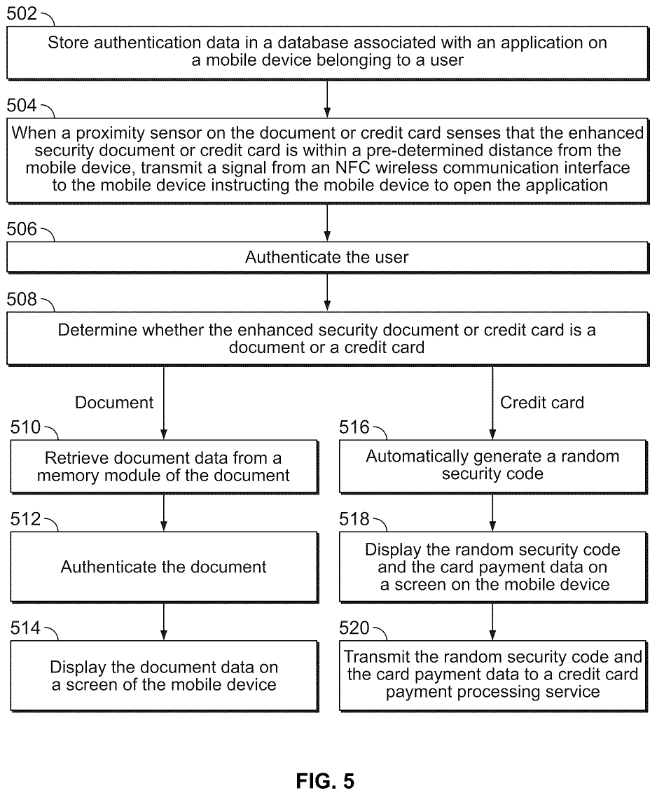

FIG. 5 shows an illustrative flowchart in accordance with principles of the disclosure. Methods may include some or all of the method steps numbered 502 through 520. Methods may include the steps illustrated in FIG. 5 in an order different from the illustrated order. The illustrative method shown in FIG. 5 may include one or more steps performed in other figures or described herein. Steps 502 through 520 may be performed on the apparatus shown in FIGS. 1-7, or other apparatus.

At step 502, authentication data may be stored in a database associated with an application on a mobile device belonging to a user. Authentication data may be data used to authenticate the user and may include biometric data.

At step 504, when a proximity sensor on the document or credit card senses that the enhanced security document or credit card is within a pre-determined distance from the mobile device, a signal from an NFC wireless communication interface on the card or document may be transmitted to the mobile device instructing the mobile device to open the application.

At step 506, the application may authenticate the user.

At step 508, the application may determine whether the enhanced security document or credit card is a document or a credit card. This determination may be necessary because the application may take different steps depending on whether it is a document or a credit card.

At step 510, if the determination is that it is a document, the application may retrieve document data from a memory module of the document and over the NFC communication interface.

At step 512, the application may authenticate the document. Authenticating the document may be as simple as analyzing the document data. In other embodiments, the document data may be compared to data stored in a database. Some of the document data may be encrypted.

At step 514, the application may display the document data on a screen of the mobile device.

At step 516, if the determination is that it is a credit card, the application may automatically generate a random security code.

At step 518, the application may display the random security code and card payment data (such as card number and expiration date) on a screen of the mobile device.

At step 520, when prompted by the user or automatically, the application may transmit the random security code and the card data to a credit card payment processing service. The data may be encrypted. Transmitting the data may be required in order to inform the credit card payment processing service of the randomly generated security code so that when the user uses the security code, it will work properly and complete the transaction.

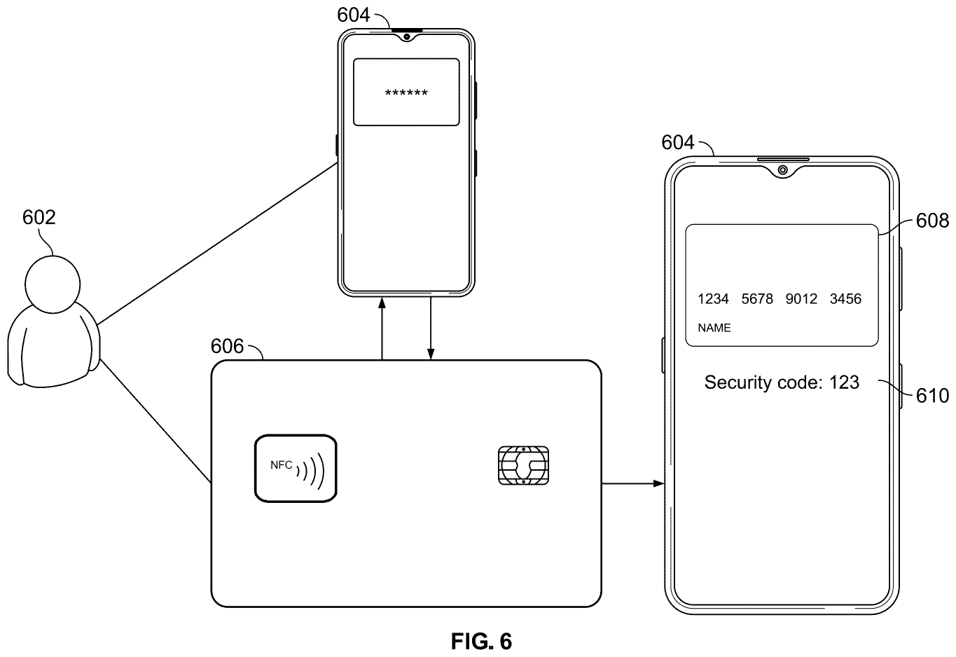

FIG. 6 shows an illustrative schematic in accordance with principles of the disclosure.

A user 602 may bring an enhanced security card 606 within a proximity of a mobile device 604.

Mobile device 604 may read data on the enhanced security card 606. This may be through an NFC communication interface.

An application on the mobile device 604 may, before authenticating the user, show no card associated with the enhanced security credit card 606.

After authenticating the user 602, the application on the mobile device 604 may display card data 608 and a randomly generated security code 610. The user 602 may then use the card data 608 and security code 610 to perform a transaction (online or otherwise).

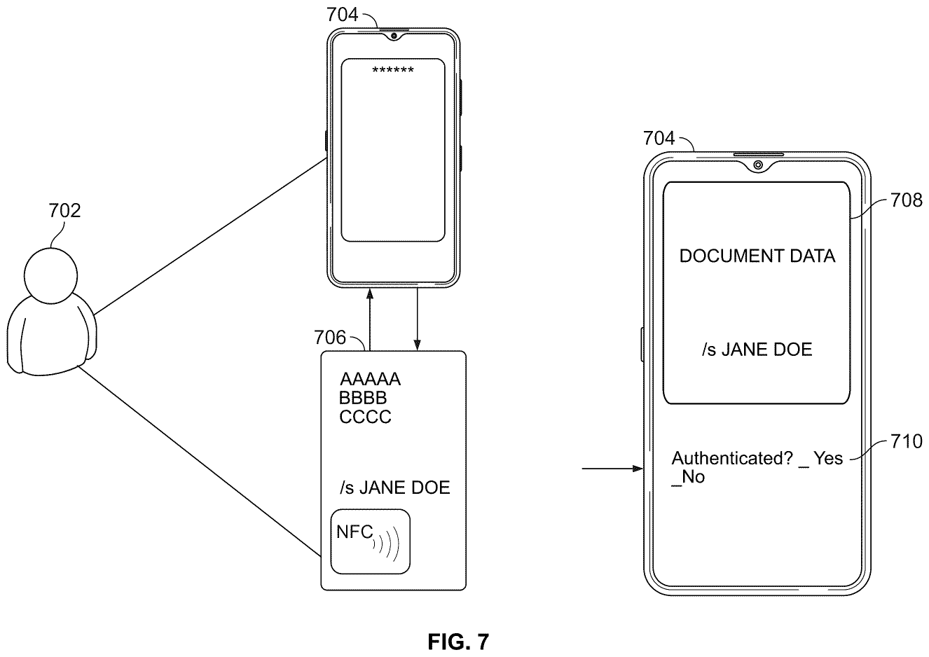

FIG. 7 shows an illustrative schematic in accordance with principles of the disclosure.

A user 702 may bring an enhanced security document 706 within a proximity of a mobile device 704.

Mobile device 704 may authenticate the user 702.

Mobile device 704 may retrieve data on the enhanced security document 706. This may be through an NFC communication interface.

An application on the mobile device 704 may, before authenticating the user, show no readable document associated with the enhanced security document 706.

After authenticating the user 702, the application on the mobile device 704 may retrieve document data 708.

The application may authenticate the document 706. The application may display the document data 708 on a screen of the mobile device 704.

The application may display whether the document is authenticated 710 or not. Other information may also be displayed.

Thus, methods and apparatus for enhanced security and authentication for credit cards and documents are provided. Persons skilled in the art will appreciate that the present invention can be practiced by other than the described embodiments, which are presented for purposes of illustration rather than of limitation, and that the present invention is limited only by the claims that follow.

1. An enhanced security credit card with a thickness not greater than 0.8 millimeters (“mm”) and a surface area not greater than 86 mm×54 mm comprising:
an EMV chip;
a front surface;
a back surface;
a non-transitory memory; and
an NFC wireless communication interface configured to provide NFC wireless communication;
wherein when the enhanced security credit card is within a pre-determined proximity of a mobile device, the enhanced security credit card is configured to:
communicate over the NFC wireless communication interface with the mobile device; and
automatically launch an application on the mobile device; and
wherein the application is configured to:
authenticate a user;
retrieve card data from the non-transitory memory;
automatically generate a random security code;
display the random security code;
display a credit card number corresponding to card payment data; and
transmit the random security code and the card data to a credit card payment processing service.

2. The enhanced security credit card of claim 1 wherein when the user is not authenticated, the application is configured to display a message.

3. The enhanced security credit card of claim 2 wherein the message states: “This card is lost or stolen.”

4. The enhanced security credit card of claim 2 wherein the non-transitory memory stores:
the credit card number;
a name of the user associated with the enhanced security credit card;
a date of expiration for the card number;
a maximum spending limit value associated with the card number; and
a telephone number associated with the card number.

5. The enhanced security credit card of claim 1 wherein the front surface bears no alphanumeric indicia identifying:
the card number;
the security code;
a date of expiration; and
a name of the user.

6. The enhanced security credit card of claim 4 wherein the back surface bears no alphanumeric indicia identifying:
the card number;
the security code;
a date of expiration; and
a name of the user.

7. The enhanced security credit card of claim 1 wherein the application is configured to, in two or more partitions on the mobile device:
authenticate the user;
automatically generate the random security code;
retrieve the credit card number corresponding to card payment data from the non-transitory memory;
retrieve a name of the cardholder from the non-transitory memory; and
retrieve a date of expiration of the credit card from the non-transitory memory.

8. The enhanced security credit card of claim 1 further comprising a power source.

9. The enhanced security credit card of claim 8 wherein the power source is rechargeable.

10. The enhanced security credit card of claim 1 wherein authentication includes one or more biometric authenticators.

11. The enhanced security credit card of claim 1 wherein the mobile device comprises two or more mobile devices each comprising a copy of the application, and the application is configured to:
i) authenticate the user on one of the two or more mobile devices;
ii) automatically generate the random security code on one of the two or more mobile devices;
iii) retrieve the credit card number corresponding to card payment data from the non-transitory memory;
iv) retrieve, on one of the two or more mobile devices, a name of the cardholder from the non-transitory memory; and
v) retrieve, on one of the two or more mobile devices, a date of expiration of the credit card from the non-transitory memory; and
wherein each of the two or more mobile devices performs at least one of i)-v).

12-20. (canceled)
